(19) United States
(12) Patent Application Publication
(10) Pub. No.: US 2005/0221259 A1
(43) Pub. Date: Oct. 6, 2005

(54) Dental or orthopaedic implant

(75) Inventor: Duncan M Anderson, North Derbyshire (GB)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Plasma Coatings Limited, Tideswell, North Derbyshire (GB)

(21) Appl. No.: 10/513,946

(22) PCT Filed: May 12, 2003
(86) PCT No.: PCT/GB03/02039

§ 371 Date: May 31, 2005

(30) Foreign Application Priority Data
May 10, 2002 (GB) 0210786.0

(51) Int. Cl. A61C 8/00

(52) U.S. Cl. 433/201.1

(57) ABSTRACT

A dental or orthopaedic implant comprises a metal or metal alloy whose surface has been converted at least over part of its area to an oxide film X, the oxide film comprising a calcium phosphate-containing material as a composite component over at least part of its area Y The metal or metal alloy preferably comprises a Group IIIA or IVA transition metal or alloy containing the same, and more preferably comprises titanium. The metal or metal alloy surface of the implant is preferably oxidised and/or the composite is preferably formed by Plasma Electrolytic Oxidation. The calcium phosphate-containing material preferably comprises an apatite, for example hydroxylapatite, or tricalcium phosphate. In a preferred PEO process, high frequency current pulses of a particular form, and within a particular frequency range, are used, combined with the generation of acoustic vibrations in 20 a sonic frequency range in the electrolyte, the frequency ranges of the current pulses and the acoustic vibrations overlapping.

The present invention relates to a dental or orthopaedic implant, and a method for forming the same.

Metal and metal alloys, for example titanium and alloys thereof, are conventionally used in the construction of orthopaedic and dental implants. Such implants are used to replace damaged or diseased bone tissue, and are implanted into living bone, for example employing bone cement, or by direct press-fit contact with the host bone.

However, micro-movement between the implant and the host bone can often result in the generation of so-called “grey-mash” around the implant, i.e. debris of cellular tissue containing metal. Implant loosening, which can ultimately result in revision surgery being required, is known to be mediated by metal particles worn away from the implant (see for example Lalor et al, The Journal of Bone & Joint Surgery, Volume 73-B, Number 1, April 1991, and Yanming et al, The Journal of Bone & Joint Surgery, Volume 83-A, Number 4, April 2001).

An object of the present invention is to seek to alleviate such problems associated with conventional implants.

According to the present invention there is provided a dental or orthopaedic implant, the implant comprising a metal or metal alloy whose surface has been converted at least over part of its area to an oxide film, the oxide film comprising a calcium phosphate-containing material as a composite component over at least part of its area.

The oxide film provides a highly wear resistant and bio-inert surface, whilst the composite oxide/calcium phosphate-containing material area affords both wear resistance and bioactive properties to encourage direct bone attachment. In particular, the oxide film can help prevent wear due to fretting, i.e. unintended motion of the implant. The oxide film can impart properties to the implant surface similar to those of heat-treated tool steel, for example so as to have a hardness on the Rockwell C hardness scale of from 50 to 60, for example 55.

Furthermore, since the oxide/calcium phosphate-containing material composite is provided by converting the metal or metal alloy surface, rather than by applying an additional coating thereto, the dimensions of the implant are not significantly altered.

The calcium phosphate-containing material is incorporated to form a composite comprising the metal or metal alloy oxide and the calcium phosphate-containing material. The calcium phosphate-containing material is thus incorporated within the structure of the oxide film, which provides strength and reliability to any areas of contact between the implant and the host bone. Calcium phosphate is a major constituent of human bones, and the calcium phosphate-containing material encourages bone growth around the implant, which is beneficial in assisting the healing process.

The metal or metal alloy is preferably a light metal or metal alloy, for example a Group IIIA or IVA transition metal or alloy containing the same. Examples of suitable metals include titanium, zirconium, and niobium, with titanium and titanium-containing alloys being particularly preferred. Titanium is particularly strong, light, corrosion resistant, and well tolerated by the human body.

The metal or metal alloy surface of the implant is preferably converted to the oxide by way of Plasma Electrolytic Oxidation (PEO). PEO is known process, in which a coating is formed on a substrate, in this case the implant, by anode-cathode oxidation in an electrolyte (typically, an alkaline electrolyte) using an alternating current (e.g. an alternating current of 50-60 Hz). Suitable PEO processes for preparing the implant of the present invention are disclosed, for example, in WO 99/31303 and WO 01/12883. PEO has an advantage over other coating techniques, for example thermal spraying, in that a relatively thin coating may be applied, which is particular suitable for coating implants which have particularly thin or intricate portions, such as wires.

Thus, those embodiments of the implant provided by the present invention in which the oxide film and/or the oxide/calcium phosphate-containing material composite are formed by PEO are particularly suited for applications where geometrically small implants are required, such as wires (e.g. toe or finger fusing wires), or where particularly delicate or complex implant shapes are required (for example, implants having small recesses, threads or holes). PEO enables the oxide film and/or composite to be relatively thin (for example, 8 to 12 8 to 12 μm, as discussed above), which should not disrupt the effectiveness of the implant.

The oxide film may have a thickness in the range of 5 to 50 μm, preferably 5 to 20 μm, more preferably 8 to 12 μm.

The calcium phosphate-containing material may comprise an apatite, for example hydroxylapatite. Crystalline hydroxyapatite has a thin amorphous phase at its surface, which can initiate an osteoconductive response from host bone. Following implantation, the hydroxylapatite may over time eventually be substantially incorporated into living bone.

Alternatively, or. additionally, the calcium phosphate-containing material may comprise tricalcium phosphate (TCP), for example α- or β-TCP, or a mixture thereof. As is the case with hydroxylapatite, α- or β-TCP is also osteoconductive, and can also thus initiate an osteoconductive response from host bone, and may over time eventually be substantially replaced by living bone. The replacement of TCP by living bone over time makes TCP coating particularly advantageous for implants which are to be removed from a patient, such as fusing pins and wires. Implants coated with TCP are more easy to remove from a patient that implants coated with hydroxylapatite.

The calcium phosphate-containing material is preferably incorporated in the oxide film by PEO, discussed above.

At least part of the area of the surface of the implant of the present invention comprises the oxide/calcium phosphate-containing material composite. However, the composite may extend over substantially the entire surface area of the implant.

In preferred embodiments of the implant of the present invention, at least a part of the surface of the implant also comprises silver particles, as an antimicrobial agent. The use of silver particles reduces the need for antibiotics, after implantation of the implant. The silver particles may be applied to the surface of the implant by PEO, discussed above, in the form of a silver salt present in the electrolyte. Suitable silver salts for this purpose include silver nitrate, silver sulphate, and silver chloride. The silver particles may be applied to the surface of the implant when forming the composite, i.e. the electrolyte used in the PEO process may comprise both the calcium phosphate-containing material, and a silver salt. Alternatively, the silver particles may be applied to the surface of the implant when oxidising the implant surface. The concentration of silver particles in the implant surface should be controlled so as not to render the implant cytotoxic. Accordingly, the composite preferably comprises 5 to 10 mol % of silver, more preferably from 6 to 9 mol %.

The surface of the metal or metal alloy implant will typically be polished prior to applying the oxide and calcium phosphate-containing coating. This facilitates' removal of implants from a patient. However, portions of the surface of the implant may be rendered macroporous, for example by having a series of surface grooves or channels, by which mechanical union of the surface with bone tissue is facilitated, which in turn provides additional stability and stress transmission of the implant. As referred to above, PEO has particular advantages in coating such macroporous portions of an implant, since it a complete coating can be applied to the implant surface, even within such grooves or channels.

According to the present invention there is also provided a method for forming a dental or orthopaedic implant, the method comprising the steps of:—
subjecting an implant having a metal or metal alloy surface to oxidation, to convert at least part of the surface of the implant into a metal or metal alloy oxide film,
and converting at least a part of the surface of the implant into a composite oxide film, by reacting the at least part of the oxide film with a calcium phosphate-containing material.

The surface of the implant is preferably at least partially converted to the oxide film by PEO, discussed above. In addition, the composite oxide film is also preferably formed by PEO. Thus, in the PEO process, the electrolyte conveniently comprises the calcium phosphate-containing material.

A preferred PEO process is available from Keronite Limited, Cambridge, United Kingdom, and involves the use of high frequency current pulses of a particular form, and within a particular frequency range, combined with the generation of acoustic vibrations in a sonic frequency range in the electrolyte, the frequency ranges of the current pulses and the acoustic vibrations overlapping. In this way, ultra-dispersed powders can be introduced into the electrolyte, the acoustic vibrations helping to form a stable hydrosol, to create coatings with specific properties.

Preferably, the method of the present invention is performed in discrete stages. Thus, in a first stage, at least a part of the surface of the implant is oxidised, following which, in a second discrete stage, the composite is formed with the calcium phosphate-containing material. An advantage of this preferred process, is that the composite is formed only to a shallow depth on the surface of the implant (for example, 2 to 5 μm). As discussed above, antimicrobial silver particles may be included in the implant surface during either or both of the oxidation and composite forming stages of this preferred method.

An example of the present invention will now be described with reference to the accompanying drawing, in which:—

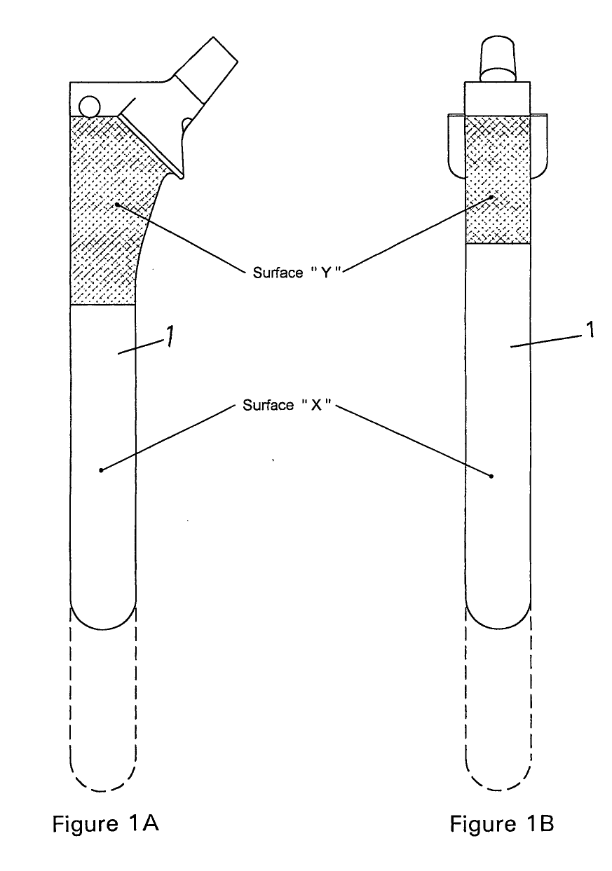

FIGS. 1A and 1B show side and front views of an implant of the present invention.

As shown in the Figures, the orthopaedic implant 1 is a Femoral Stem. The implant 1 comprises two areas, designated “X” and “Y”. Prior to processing, area “X” of the implant 1 has a polished surface. In contrast, area “Y” has a macroporous surface, formed by a series of surface grooves, shown as hatched areas in the Figures. The macroporous surface facilitates mechanical union of area “Y” with bone tissue, which in turn provides additional stability and stress transmission of the implant. Area “X” is not required to form a union with the host bone, but will have intimate contact with the bone, whereas area “Y” is intended to form a union with the host bone.

Both areas “X” and “Y” have a thin outer oxide film, formed by a PEO treatment. Subsequently, a further PEO treatment is applied to both areas, during which submicron particle size tricalcium phosphate (TCP) is incorporated into the oxide film to form a composite therewith. The TCP preferably forms a component of the electrolyte used during the PEO process. As referred to above, PEO is particularly useful for coating areas of particular surface detail, such as the grooved surface area “Y”, since it allows for coating of the inside of the grooves.

The metal oxide film provides a highly wear resistant surface. Incorporating the calcium phosphate as part of the PEO manufacturing process enables the formation of a highly wear resistant yet bone compatible surface for the purposes of bone attachment.

The metal or metal alloy is preferably a light metal or metal alloy, for example a Group IIIA or IVA transition metal or alloy containing the same. Examples of suitable metals include titanium, zirconium, and niobium, with titanium and titanium-containing alloys being particularly preferred. Titanium is particularly strong, light, corrosion resistant, and well tolerated by the human body.

In a method of forming the implant, the implant is immersed in tanks containing suitable electrolyte for forming the respective films at surfaces “X” and “Y”. The formation of the composite film is preferably carried out in a tank in which the electrolyte includes TCP, as discussed above. For those preferred methods which comprise two discrete immersion steps, the area of implant surface not being converted in each step can be masked off.

The electrolyte preferably also comprises a silver salt, for incorporation of antimicrobial silver particles into the surface film. Suitable silver salts include silver nitrate, silver sulphate, and silver chloride. By incorporating a silver salt in the electrolyte, the silver particles and calcium phosphate-containing material are simultaneously incorporated onto the surface of the implant.

1-24. (canceled)

25. A dental or orthopaedic implant, the implant comprising a material selected from the group consisting of metals and metal alloys whose surface has been converted at least over part of its area to an oxide film, the oxide film comprising a calcium phosphate-containing material as a composite component over at least part of its area.

26. An implant according to claim 25 wherein the material is selected from the group consisting of Group IIIA and IVA transition metals and alloys containing the same.

27. An implant according to claim 26 wherein the material is selected from the group consisting of titanium, zirconium, and niobium.

28. An implant according to claim 27 wherein the material comprises titanium.

29. An implant according to claim 28 wherein the surface of the implant is oxidised.

30. An implant according to claim 28 wherein the composite is formed by Plasma Electrolytic Oxidation.

31. An implant according to claim 25 wherein the oxide film has a thickness in the range of 8 to 12 μm.

32. An implant according to claim 25 wherein the calcium phosphate-containing material comprises tricalcium phosphate.

33. An implant according to claim 32 wherein the tricalcium phosphate is selected from the group consisting of A-TCP, P-TCP and a mixture thereof.

34. An implant according to claim 25 wherein the composite extends over substantially the entire surface area of the implant.

35. An implant according to claim 25 wherein at least a part of the surface of the implant comprises silver particles.

36. An implant according to claim 25 wherein the silver particles are applied to the surface of the implant by plasma electrolytic oxidation.

37. An implant according to claim 36 wherein the silver particles are present as a silver salt present in the electrolyte during the plasma electrolytic oxidation process.

38. An implant according to claim 37 wherein the silver salt is selected from the group consisting of silver nitrate, silver sulphate, silver chloride and mixtures thereof.

39. An implant according to claim 35 wherein the silver particles are applied to the surface of the implant when forming the composite.

40. An implant according to claim 35 wherein the silver particles are applied to the surface of the implant when oxidising the implant surface.

41. An implant according to claim 35 wherein the composite comprises 6 to 9 mol % of silver.

42. An implant according to claim 25 wherein at least part of the surface of the implant is macroporous.

43. An implant according to claim 42 wherein the macroporous surface of the implant is formed by grooves or channels.

44. A method for forming a dental or orthopaedic implant, the method comprising the steps of:—
subjecting an implant having a surface comprising a material selected from the group consisting of metals and metal alloys to oxidation, to convert at least part of the surface of the implant into one of a metal oxide film and a metal alloy oxide film,
and converting at least a part of the surface of the implant into a composite oxide film, by reacting the at least part of the oxide film with a calcium phosphate-containing material.

45. A method according to claim 44 wherein the surface of the implant is at least partially converted to the oxide film.

46. A method according to claim 44 wherein the composite oxide film is formed by plasma electrolytic oxidation.

47. A method according to claim 44 wherein the surface of the implant is oxidised in a first stage, following which the composite is formed with the calcium phosphate-containing material in a second stage.

48. A method according to claim 47 which employs high frequency current pulses of a predetermined form, and within a predetermined frequency range, combined with the generation of acoustic vibrations in a sonic frequency range in the electrolyte, the frequency ranges of the current pulses and the acoustic vibrations overlapping.

49. A dental or orthopaedic implant wherein at least a part of the surface of the implant comprises silver particles as an antimicrobial agent.

50. Use of tricalcium phosphate as a coating for a dental or orthopaedic implant.
